(19) United States
(12) Patent Application Publication
(10) Pub. No.: US 2025/0003263 A1
(43) Pub. Date: Jan. 2, 2025

(54) MOTOR VEHICLE DOOR ARRANGEMENT

(71) Applicant: KIEKERT AKTIENGESELLSCHAFT, Heiligenhaus (DE)

(72) Inventors: Tobias KLOCKE, Solingen (DE); Thorsten BENDEL, Oberhausen (DE); Uwe REDDMANN, Essen (DE)

(73) Assignee: KIEKERT AKTIENGESELLSCHAFT, Heiligenhaus (DE)

(21) Appl. No.: 18/709,556

(22) PCT Filed: Dec. 16, 2022
(86) PCT No.: PCT/DE2022/100961

§ 371 Date: May 13, 2024

(30) Foreign Application Priority Data
Dec. 16, 2021 (DE) 10 2021 006 214.0

(51) Int. Cl. E05B 81/20; E05B 81/06; E05B 81/14; E05B 81/30; E05B 81/56; E05B 81/66; E05B 81/70; E05F 15/40; E05F 15/611

(52) U.S. Cl. CPC E05B 81/20; E05B 81/06; E05B 81/56; E05B 81/66; E05B 81/70; E05F 15/40; E05F 15/611; E05B 81/14; E05B 81/30; E05Y 2201/434; E05Y 2900/531

(57) ABSTRACT

The invention relates to a motor vehicle door arrangement which is equipped with at least one electromotive drive (4, 18) and a closing device (6). The electromotive drive (4, 18) is configured to open a door leaf (1) into a predefined gap position (gap S) in comparison with the motor vehicle body (2) and additionally to implement at least one functional position of the closing device (6). According to the invention, the functional position of the closing device (6) is a safety position and/or an open position.

The invention relates to a motor vehicle door arrangement, comprising at least one electric motor-driven drive and a closure device, the electric motor-driven drive being configured to open a door leaf into a predefined gap position in relation to the motor vehicle body and additionally to implement at least one functional position of the closure device.

Motor vehicle door arrangements make use of the electric motor-driven drive to open the door leaf, for example. For this purpose, the electric motor-driven drive may act on a lock holder and thus ensure the desired opening movement, as described in detail, inter alia, in DE 10 2020 109 770 A1, which can be traced back to the applicant. Another approach in this context is, inter alia, the subject matter of DE 10 2011 015 669 A1. In this case, the electric motor-driven drive works on a lever whose rotary movement is converted into a movement that opens the door leaf.

In the generic prior art according to DE 10 2019 107 645 A1, an actuator is acted on in a first direction by the electric motor-driven drive in order to realize a closing movement of the door leaf and actuation in a second direction corresponds to the opening of the door leaf. For this purpose, the actuator works on a locking mechanism, which is the closure device described above. Consequently, the electric motor-driven drive assumes, in the known teaching, dual functionality in such a way that a closing function is realized on the one hand and the opening function on the other.

In this case, the opening movement is carried out to such an extent or in such a way that an “ice-breaker function” can thus be realized. The actuator is equipped with an ice-breaker cam for this purpose. The ice-breaker function ensures that the door leaf is opened even if the door leaf is “frozen”. Normally, a rubber door seal extending around the door leaf ensures that, when the closure device is open, the door leaf can be opened by spring forces generated thereby, and then opened manually or using the electric motor-driven drive.

However, if the closure device does not open fully due to freezing rain or snow, for example, or if it is not possible to open the door leaf using an opening device, the ice-breaker function described above must be used. This ensures that the door leaf is released with respect to the surrounding rubber door seal, for example, and the frozen state can be overcome. This often requires high forces of several decanewtons to be applied to the door leaf.

For this reason, the known teaching according to DE 10 2019 102 645 A1 works using an electric motor-driven drive, which ensures that the door leaf is both closed and opened in the sense of an ice-breaker function in its two functional directions. This means that the known electric motor-driven drive can already be used for the two different functions described, and therefore an additional drive is not required for the ice-breaking function.

In DE 10 2018 100 254 A1, a motor vehicle lock can realize a closing movement and an opening movement, as well as an additional opening movement of a pawl, with the aid of an actuating arrangement. For this purpose, the actuating arrangement has a first actuating element and a second actuating element that can be actuated separately therefrom.

The prior art has essentially proven itself when it comes to realizing, for example, the closing movement of the door leaf and the opening thereof or the ice-breaker function by means of a corresponding electric motor-driven drive. In practice, however, this results in problems in that known motor vehicle door arrangements are not necessarily equipped, or do not have to be equipped, with a closure drive. This limits the field of application of the known teaching. The invention as a whole seeks to remedy this.

The technical problem addressed by the invention is that of developing such a motor vehicle door arrangement in such a way that universal implementation is made available with the aid of at least one electric motor-driven drive alongside a simultaneously structurally simple design.

In order to solve this technical problem, the invention proposes, for a motor vehicle door arrangement of the type in question within the context of the invention, that the functional position of the closure device is a safety position and/or an open position.

Thus, according to the invention, the electric motor-driven drive firstly and very generally ensures that the door leaf is opened into the predetermined gap position in relation to the motor vehicle body. In this case, this gap position can advantageously correspond to an ice-breaker position or be designed in such a way that the door leaf, which may be frozen with respect to a surrounding rubber door seal, or any ice layer between the door leaf and the motor vehicle body can be safely broken open thereby. In this context, gap positions of the door leaf in relation to the motor vehicle body of a few millimeters up to 10 mm or even more have proven to be particularly favorable.

In addition, according to the invention, the electric motor-driven drive is not only capable of and designed for opening the door leaf into the predetermined gap position in relation to the motor vehicle body, but also represents at least one functional position of the closure device. According to the invention, this functional position of the closure device is a safety position and/or an open position of the closure device.

If the closure device is advantageously designed as a motor vehicle door lock having a locking mechanism consisting substantially of a rotary latch and pawl, the safety position of the closure device or the motor vehicle lock typically corresponds to an “unlocked/secured” position. Specifically, this can involve various safety positions such as “unlocked/locked”, “child-lock off/child-lock on”, “anti-theft device off/anti-theft device on”. This depends on the specific design of the motor vehicle door lock and also its position in the motor vehicle.

In addition and as an alternative thereto, the functional position additionally realized with the aid of the electric motor-driven drive can also be designed as the open position of the closure device. When the motor vehicle door lock is designed as a closure device, the open position usually corresponds to an electric motor-driven opening of the locking mechanism. This means that the electric motor-driven drive can be advantageously used to lift the pawl from its latching engagement with the rotary latch. As a result, the rotary latch opens in a spring-assisted manner and releases a previously caught locking bolt.

If the electric motor-driven drive is designed to implement a safety position, it can be used, for example, to move the closure device or the motor vehicle door lock to the “unlocked/locked” functional position. This corresponds to an external actuating lever chain regularly performing an idle stroke with respect to the locking mechanism when acted upon in the “locked” position, whereas the external actuating lever chain, in the “unlocked” position, allows for the locking mechanism to be opened. If the electric motor-driven drive works on the motor vehicle door lock in terms of “child-lock off/child-lock on”, the unlocked position at a rear motor vehicle side door means that said door be opened via an interior actuating lever chain, whereas in the “child-lock on” position, opening from the inside is not possible. In both cases, however, the rear motor vehicle side door in question can be opened from the outside via an external actuating lever chain.

Finally, the “anti-theft device off” state corresponds to the fact that both an internal actuating lever chain and an external actuating lever chain are closed, and cause the locking mechanism to open when acted upon, whereas in the “anti-theft device on” functional position, both lever chains are idle and the locking mechanism accordingly cannot be opened.

According to the invention, the (single) electric motor-driven drive is now capable of both opening the door leaf and moving the closure device into the safety position and/or open position, i.e. moving the locking mechanism of the motor vehicle door lock into the “locked/unlocked”, “child-lock off/child-lock on” or “anti-theft device off/anti-theft device on” positions, for example. In principle, combinations are of course also possible, as is the situation where it is only possible to move to one of the aforementioned safety positions using the (single) electric motor-driven drive, for example only the “locked” position.

In any case, the (single) electric motor-driven drive in question is used at least twice in the case described, specifically to implement the safety position or open position of the closure device and in particular of the motor vehicle door lock on the one hand, and to ensure opening of the door leaf on the other hand. In this case, when opening the door leaf, it is important in particular to realize an ice-breaker function, i.e. to move the door leaf into a gap position in relation to the motor vehicle body, which enables any ice layer to be broken up or the frozen door leaf to be released. Either way, the electric motor-driven drive in question is used for the multiple functions described, thus providing a particularly compact and cost-effective variant.

To be specific, the electric motor-driven drive acts on an opening device for the door leaf. In this case, the opening device on the one hand and the closure device on the other hand can be separate in terms of location and function. In this case, the electric motor-driven drive may be integrated into the opening device or the closure device. However, it is also possible to provide and implement the electric motor-driven drive separately from both the opening device and the closure device in terms of location and function.

A preferred variant is characterized in that the opening device is integrated into the closure device. In this case, the electric motor-driven drive can also be particularly advantageously integrated into the closure device such that in this variant both the safety position and the open position of the closure device can be achieved in a simple manner with the aid of the electric motor-driven drive as well as the action on the opening device as a component of the closure device while having regard to a compact design. In addition, in this case a single electric motor-driven drive is usually implemented.

In another variant, a first electric motor-driven drive is designed to act on the opening device and to implement the safety position of the closure device and, in addition, a second electric motor-driven drive is designed to act on the opening device and to implement the open position of the closure device. In this case, the first electric motor-driven drive is therefore used for the combined action on the opening device and for implementing the safety position of the closure device. The second electric motor-driven drive is used to act on the opening device again and also to implement the open position of the closure device. In other words, both electric motor-driven drives perform a dual function by implementing both the opening device and implementing the safety position or open position of the closure device.

In this context, it has proven to be particularly favorable if both electric motor-driven drives act on the opening device in combination. That is to say that the two electric motor-driven drives are used together to act on the opening device. As a result, particularly power-intensive ice-breaker functions can also be realized and implemented, which would otherwise be impossible to control (if only one electric motor-driven drive were used). It goes without saying here that both electric motor-driven drives collectively act on the opening device and act thereon in the sense of joint opening of the door leaf.

According to a further advantageous embodiment, at least one sensor is provided for determining the opening path of the door leaf. In this case, the sensor can be a component of the opening device and may, for example, measure the opening path covered by the opening device during the opening process.

In principle, for this purpose the at least one sensor in question can be arranged on the door leaf and/or in the opening device and/or in the closure device. That is to say that it is possible to place the sensor in or on the door leaf, as required, in order to record movements of the door leaf in relation to the motor vehicle body and use them as a control signal for the action of the electric motor-driven drive. This is because as soon as the door leaf reaches or has reached the specified gap position in relation to the motor vehicle body, the sensor sends a corresponding signal to a control unit, which in turn ensures that the electric motor-driven drive is switched off. Alternatively or additionally, the sensor can also be arranged in the opening device, for example can measure the opening path directly at this point. Alternatively or additionally, the sensor can also be arranged in the closure device.

Of course, a plurality of sensors can also be used at this point, for example one sensor in the closure device and an additional sensor in the opening device. In this case, the sensor in the closure device may advantageously be designed as a rotary latch sensor if the closure device is the motor vehicle door lock. The sensor in or on the opening device may be what is known as an ice-breaker switch or ice-breaker sensor, i.e. one that only emits a signal to the control unit when the opening device reaches a gap position of the door leaf in relation to the motor vehicle body that leads to the desired ice breakage or represents the ice-breaker function.

The electric motor-driven drive can advantageously be a single electric motor-driven drive. Furthermore, this is usually designed as a component of the motor vehicle door lock provided that the closure device is designed as a motor vehicle door lock having a locking mechanism consisting substantially of a rotary latch and pawl. In this case, the design of the sensor can be implemented and realized in such a way that the sensor is a switch which scans a position of the rotary latch, which is part of the locking mechanism in the motor vehicle lock, via an interposed and preferably spring-loaded eccentric, for example. In principle, a wedge or another scanning element can also be interposed instead of the eccentric. The eccentric, the wedge or the relevant scanning element can of course also be provided and implemented in the event that the sensor is to be used to scan the opening path of the opening device or the achievement of the ice-breaker function. The sensor can also be used to act on an existing door drive.

In other words, an existing sensor can also be used as a sensor for determining the opening path of the door leaf, which sensor can be used, for example, to actuate a door drive assigned to the door leaf as soon as the door leaf has been opened far enough that the door leaf can be swung open by means of the door drive as a whole. This results in synergy effects because additional sensors are not required. The same applies to the one or more electric motor-driven drives, which may also be present according to the invention or are additionally used within the scope of the invention to open the door leaf until the predetermined gap position of the door leaf in relation to the motor vehicle body, which gap position advantageously corresponds to the ice-breaker function, is reached. As a result, the described ice-breaker function can be easily added later on because it uses existing hardware elements. Since the electric motor-driven drive also has a dual or even multiple use, further synergy effects are realized as part of a compact and cost-saving design. These are the main advantages.

In the following, the invention will be explained in more detail on the basis of a set of drawings showing only one embodiment; in which:

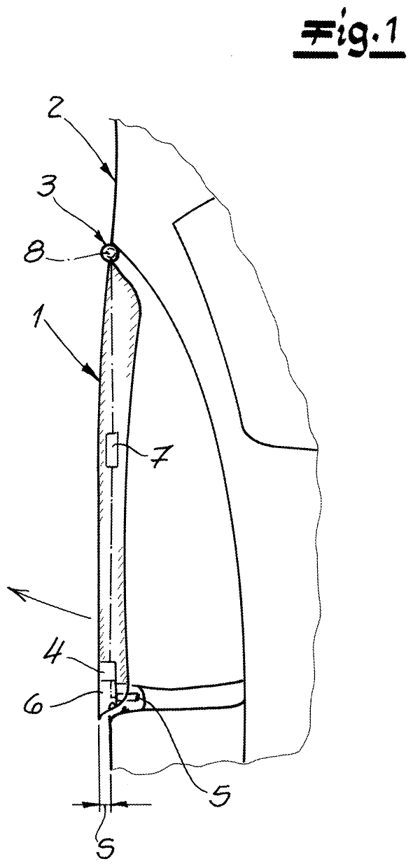

FIG. 1 is a schematic sectional view of a motor vehicle door arrangement according to the invention,

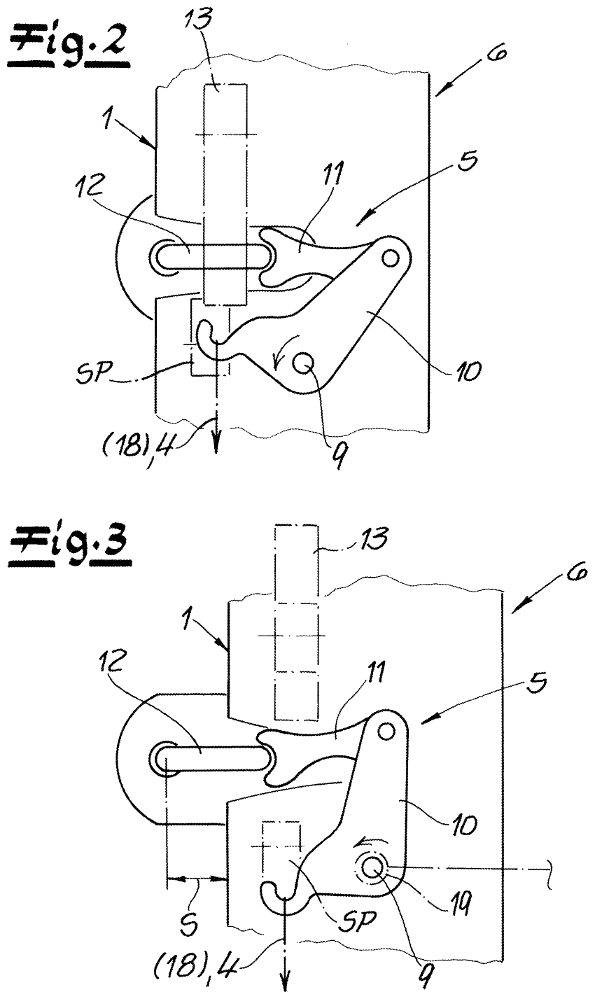

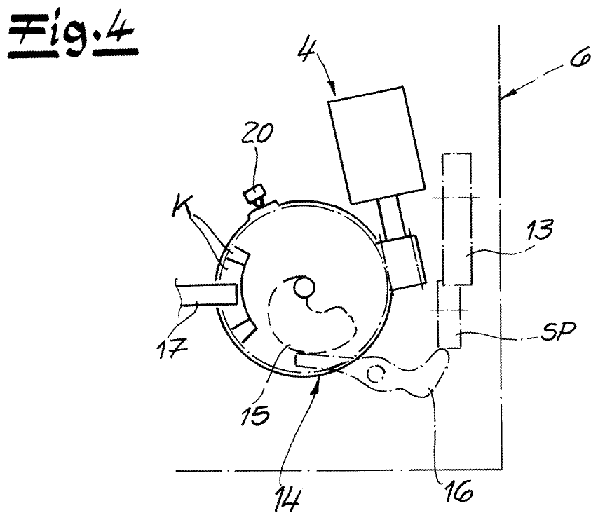

FIGS. 2 and 3 show the closure device shown in FIG. 1 in different functional positions,

FIG. 4 shows the closure device in another variant, and

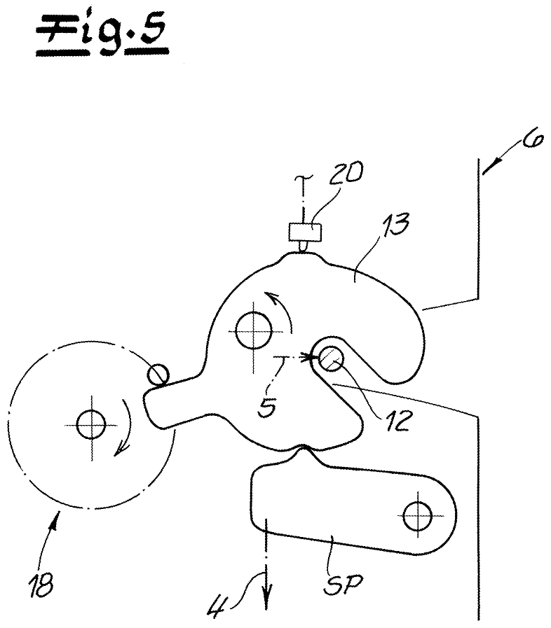

FIG. 5 shows a further basic modification of the closure device.

FIG. 1 shows a motor vehicle door arrangement which has at least one door leaf 1 which can be swung out and opened relative to a motor vehicle body 2, as indicated by a corresponding arrow in FIG. 1. For this purpose, the door leaf 1 can be pivoted about an associated axis 3.

It should be emphasized in this context that the door leaf 1 can form more than just a component of a motor vehicle side door shown by way of example in FIG. 1. Instead, the motor vehicle door arrangement realized according to the invention is one that in principle not only covers door leaves 1 that can be pivoted relative to the motor vehicle body 2, but rather, the term motor vehicle door arrangement is to be interpreted universally and broadly and, according to the invention, includes both pivotable door leaves 1 and those which can be displaced relative to the motor vehicle body 2, such as a sliding door leaf (not explicitly shown). In addition, the door leaf 1 can also be a component of a tailgate, a hood or any other movable flap located in or on the motor vehicle.

Either way, the motor vehicle door arrangement is equipped with at least one electric motor-driven drive 4, with the aid of which the door leaf 1 can be opened, specifically into a predetermined gap position associated with a gap S, as can best be understood from FIGS. 2 and 3. For this purpose, the electric motor-driven drive 4 acts on an opening device 5.

In addition, the basic structure of the motor vehicle door arrangement includes a closure device 6 which, according to the embodiment, is designed as, but not limited to, a motor vehicle door lock 6. In this case, a control unit 7, which also processes signals from a sensor 8, is used to actuate the electric motor-driven drive 4. In the variant according to FIG. 1, the sensor 8 is a rotation angle sensor, i.e. a sensor 8 on the door leaf 1 in the region of its axis 3, which can be used to record an opening path of the door leaf 1 relative to the motor vehicle body 2, specifically until the door leaf 1 describes the gap S indicated in FIG. 3 relative to the motor vehicle body 2.

It can be seen that the closure device 6, the electric motor-driven drive 4 and the control unit 7, as well as the opening device 5, are arranged inside the door leaf 1. Of course, this is only an example and is fundamentally not mandatory. According to the invention, the electric motor-driven drive 4 is now not only capable of and designed for opening the door leaf 1 into the predetermined gap position or for realizing the gap S, but the electric motor-driven drive 4 can additionally also be used to implement and define at least one functional position of the closure device 6. This functional position of the closure device 6 or the motor vehicle door lock 6 realized in this case is a safety position and/or an open position, as will be explained in more detail below.

In other words, the electric motor-driven drive 4 is capable of moving to safety positions, for example, such as “unlocked/locked” of the motor vehicle door lock 6. In addition, the electric motor-driven drive 4 is used to act on the opening device 5 for the door leaf 1, i.e. it can be used to act on the door leaf 1 until it reaches the predetermined gap position relative to the motor vehicle body 2.

In principle, it is possible for the opening device 5 on the one hand and the closure device 6 on the other hand to be separate from each other in terms of location and function. In this case, the opening device 5 may, for example, be one in which an opening slider or an opening pin is extended relative to the door leaf 1, for example with the aid of the electric motor-driven drive 4, so that in this way the opening slider or opening pin in question moves against the motor vehicle body 2 and the door leaf 1 is thereby swung open about the axis 3. According to the embodiment, however, the opening device 5 is integrated into the closure device 6 or the motor vehicle door lock 6. This can be seen from the individual illustrations in FIGS. 2 and 3.

In this case, FIG. 2 shows the state of the opening device 5 in which it is not acted on, whereas FIG. 3 shows the state of the opening device 5 in which it is acted on by the electric motor-driven drive 4. In fact, at this point the opening device 5 is designed to have a toggle lever 10, 11 that can be pivoted about an axis 9, but is not restricted thereto. In this case, one toggle lever arm 11 of the toggle lever 10, 11 can move against a lock holder 12, which typically interacts with a locking mechanism 13, SP consisting of a rotary latch 13 and pawl SP arranged inside the motor vehicle door lock 6. FIG. 2 shows a cutout of the rotary latch 13 which catches the lock holder 12 in the closed position and which is secured in its latched state by means of the pawl SP.

The opening movement of the opening device 5 now corresponds to one toggle lever arm 10 of the toggle lever 10, 11 being acted on by the electric motor-driven drive 4 counter-clockwise about the axis 9, as indicated by an arrow in FIG. 3. As a result, the toggle lever arm 10 acted upon by the electric motor-driven drive 4 performs the counterclockwise movement indicated in FIG. 3 so that as a result the other toggle lever arm 11 moves against the lock holder 12 and in this way the motor vehicle door lock 6 moves relative to the lock holder 12 connected to the motor vehicle body 2 so that the gap S is ultimately created, as can be understood by comparing FIGS. 2 and 3.

According to the invention, the electric motor-driven drive 4 is now not only designed for and capable of acting on the opening device 5, but can also realize and implement the open position of the closure device 6. This can best be understood from FIG. 4, which shows the closure device 6 in a further embodiment. In fact, it can be seen that the electric motor-driven drive 4 uses an electric motor to rotate an output disk 14, which is equipped on one of its surfaces with a cam 15 that acts on a release lever 16 in order to be able to lift the pawl SP there from its latching engagement with the rotary latch 13. A contour K is provided on the other opposite surface of the output disk 14, which contour acts on an adjusting lever 17, with the aid of which a linear movement can be performed (as outlined). This linear movement can be used, in the context of the illustration according to FIG. 3, so that the toggle lever 10, 11 is—as described—pivoted by means of the electric motor-driven drive 4 indicated in said drawing in a stylized fashion, and consequently the opening device 5 is acted upon, as desired. In other words, the electric motor-driven drive 4 is used both to act on the opening device 5 and to implement the open position of the closure device 6.

In principle, two different electric motor-driven drives 4, 18 can also be used at this point, as can be seen from a comparison with FIG. 5. In fact, the electric motor-driven drive 4 can also be used as the first electric motor-driven drive 4 for acting on the opening device 5 and for implementing a safety position of the closure device 6. In this case, the adjusting lever 17 does not work on the toggle levers 10, 11, but rather, with its help and according to the linear movement generated, a desired safety position of the closure device or of the motor vehicle door lock 6 is realized and implemented. This can be done, for example, by coupling and uncoupling a coupling element using the adjusting lever 17.

The coupling element is part of an actuating lever chain that is closed when the coupling element is coupled and is open when it is uncoupled. The coupled state typically corresponds to the “unlocked” functional position, whereas the uncoupled state corresponds to the “secured” position of the actuating lever chain. Depending on the design of an associated safety device, the previously mentioned safety positions, such as “locked/unlocked”, can thus be realized if the coupling element is, for example, part of an external actuating lever chain. In the case of an internal actuating lever chain and an implemented child-lock function, the coupling element is, in contrast, a component of the relevant internal actuating lever chain. If the adjusting element 17 is used to transfer both a coupling element, as part of an internal actuating lever chain, and an external actuating lever chain into the corresponding “coupled” or “uncoupled” state, the corresponding functional positions “anti-theft device off” and “anti-theft device on” can thus be realized and implemented.

In any event, in this case the first electric motor-driven drive 4 is used to act on the opening device 5 and to realize the safety position of the closure device 6. With the aid of the further second electric motor-driven drive 18, as shown in FIG. 5, the opening device 5 can now also be acted on, and an open position of the closure device 6 can also be realized. For this purpose, the second electric motor-driven drive 18 acts on the rotary latch 13, for example, and, by means of its clockwise movement shown in FIG. 5, ensures that the rotary latch 13 not only assumes its open position in relation to the lock holder 12, but is also opened beyond the lock holder 12 and beyond a pre-latching position with the pawl SP so that ultimately the gap S between the door leaf 1 and the motor vehicle body 2 is in turn observed.

In this case, both electric motor-driven drives 4, 18 can act on the opening device 5 in combination by both electric motor-driven drives 4, 18 collectively acting on the toggle lever 10, 11, as indicated in FIG. 3. As a result, a particularly effective ice-breaker function can be realized and implemented.

As already explained, the sensor 8 can be used to record an opening path of the door leaf 1. In this case, the signals from the sensor 8 are received by the control unit 7 and converted in such a way that the electric motor-driven drive 4, 18 is stopped when the gap S corresponding to the ice-breaker function is reached. As described, the sensor 8 is designed as a rotation angle sensor integrated into the axis 3 of the door leaf 1.

In addition, a further sensor 19 can be implemented, which in this case is designed as a component of the opening device 5 and specifically measures the pivoting movement of the toggle lever arm 10 about its axis 9, as indicated in FIG. 3. A further third sensor 20 can also be used to record the position of the rotary latch 13. The sensor 20 in question may be a pre-existing sensor 20 for the main latching detection of the rotary latch 13. Of course, the second sensor 19 and the third sensor 20 are collectively connected to the control unit 7, in a similar way to the first sensor 8.

Furthermore and essentially, electric motor-driven drive 4 is designed to be the only electric motor-driven drive 4, which moreover constitutes a component of the motor vehicle door lock 6. For this purpose, the single electric motor-driven drive 4 in question is integrated into the motor vehicle door lock 6. Either way, the single electric motor-driven drive 4 or the first electric motor-driven drive 4 as well as the second electric motor-driven drive 18 are used for multiple functions, as has been described in detail. In addition, the sensor 20 assigned to the rotary latch 13 can in principle also be provided on the outer circumference of the output disk 14, as shown alternatively in FIG. 4.

### LIST OF REFERENCE SIGNS

1 Door leaf
2 Motor vehicle body
3 Axis
4, 18 Electric motor-driven drive
4 First electric motor-driven drive
5 Deployment device
6 Motor vehicle door lock
7 Control unit
8 Sensor
9 Axis
10, 11 Toggle lever
10, 11 Toggle lever arm
12 Lock holder
13, 14 Locking mechanism
13 Rotary latch
14 Output disk
15 Cam
16 Release lever
17 Adjustment lever
18 Second electric motor-driven drive
19, 20 Sensors
S Gap
SP Pawl
K Contour

1. A motor vehicle door arrangement, comprising:
at least one electric motor-driven drive for acting on a door leaf, and
a closure device,
the electric motor-driven drive being configured to open the door leaf into a predefined gap position in relation to a motor vehicle body and additionally to implement at least one functional position of the closure device, wherein the at least one functional position of the closure device includes a safety position corresponding to an unlocked and secure position of the closure device, and/or an open position of the closure device.

2. The motor vehicle door arrangement according to claim 1, further comprising and opening device for opening the door leaf, wherein the electric motor-driven drive acts on the opening device for the door leaf.

3. The motor vehicle door arrangement according to claim 2, wherein the opening device on the one hand and the closure device are positioned at separate locations.

4. The motor vehicle door arrangement according to claim 2, wherein the opening device is integrated in the closure device.

5. The motor vehicle door arrangement according to claim 2, wherein the at least one electric motor-driven drive comprises a first electric motor-driven drive configured to act on the opening device and configured to implement the safety position of the closure device, and a second electric motor-driven drive configured to act on the opening device and configured to implement the open position of the closure device.

6. The motor vehicle door arrangement according to claim 5, wherein both the first and second electric motor-driven drives act on the opening device in combination.

7. The motor vehicle door arrangement according to claim 1, further comprising at least one sensor for determining an opening path of the door leaf.

8. The motor vehicle door arrangement according to claim 7, wherein the at least one sensor comprises a sensor located one or more of on the door leaf, in the opening device, and in the closure device.

9. The motor vehicle door arrangement according to claim 1, wherein the closure device comprises a motor vehicle door lock having a locking mechanism including a rotary latch and a pawl.

10. The motor vehicle door arrangement according to claim 9, wherein a single electric motor-driven drive is provided as a component of the motor vehicle door lock.

11. The motor vehicle door arrangement of claim 9, further comprising a sensor for determining an opening path of the door leaf, the sensor being configured to scan a position of the rotary latch.

12. The motor vehicle door arrangement of claim 11, wherein the locking mechanism includes a spring-loaded eccentric or wedge that is scanned by the sensor to scan the position of the rotary latch.

13. The motor vehicle door arrangement according to claim 2, wherein the electric motor-driven drive is integrated in the opening device.

14. The motor vehicle door arrangement according to claim 2, wherein the electric motor-driven drive is integrated in the closure device.

15. The motor vehicle door arrangement according to claim 7, further comprising a control unit configured to process signals from the at least one sensor and to control the electric motor-driven drive based on the signal processing.

16. The motor vehicle door arrangement according to claim 2, wherein the opening device comprises a toggle lever and a slider that is extended or retracted by operation of the toggle lever.

17. The motor vehicle door arrangement according to claim 5, further comprising an adjusting lever and a coupling element for that is changeably coupled with respect to first and second electric motor-driven drives
